(19) United States
(12) Patent Application Publication
(10) Pub. No.: US 2024/0155319 A1
(43) Pub. Date: May 9, 2024

(54) Integrated Security System For Protecting The Communities

(71) Applicant: Budur Jibril Ibrahim, Jeddah (SA)

(72) Inventor: Budur Jibril Ibrahim, Jeddah (SA)

(21) Appl. No.: 17/981,410

(22) Filed: Nov. 5, 2022

(51) Int. Cl. H04W 4/90; G08B 25/00; G08B 25/10; H04N 23/90; H04W 4/029

(52) U.S. Cl. CPC H04W 4/90; G08B 25/006; G08B 25/10; H04N 23/90; H04W 4/029

(57) ABSTRACT

The following integrated security system the first part is about the existence of a program or system that helps security offices to monitor the location of the incoming call, the second part of the system is the presence of a security device installed in the areas that contains distributed security surveillance cameras and a system of security sensors. This security innovation depends on specialized government platforms such as: security patrols, civil defense, ambulance, etc.

The first part is through the electronic tracking feature of the chips via phone numbers, the alert reaches the central emergency unit and the nearest patrol in the incoming contact area follows up on the situation.

The second part of the system is the presence of distributed cameras with high security features, and the sensors of the security system for detecting weapons and prohibited substances.

### 1. THE FIELD OF THE INVENTION

The present invention relates generally to the field of security, information technology, artificial intelligence, and in particular to the field of GPS and contact tracking, and the security camera system with the security sensor systems for detecting weapons and prohibited substances.

### 2. DESCRIPTION OF THE RELATED TECHNICAL FIELD

The first part of the invention is concerned with the tracking feature through the incoming call to the security center.

One of the similar previous technologies in the same field is the automated response system when calling the emergency number, by recording and following up on the reports and visuals provided by these callers, and the special part for listening to security news and the instructions to prepare them for the purpose of broadcasting them through the automated response, where the call is received, through the system the options for services provided by the system to the caller are displayed.

Among these main options are:
(1) Reports and security information
(2) Notes and visuals
(3) Security events
(4) Emergency numbers
(5) Talk to the sheriff directly

Where the caller receives a message from the system asking him to identify himself, in order to be directed according to this definition, the emergency services respond to a large group of callers who require inquiring about one of the emergency numbers.

Among the previous technologies which are also used in the same field is the GPS vehicle tracking system to direct the vehicles and ambulances closest to the location of the incident and rescue the injured by monitoring the map to find the vehicle equipped with the necessary facilities for a specific case and contact them directly to reach the location of the incident.

That is by locating police cars, fire trucks, ambulances and dog teams easily and sending them to the required place and determining the most appropriate path to reach the site.

While the current invention in this innovative idea saves time and effort, as the security center helps in speeding up communication and determining the location automatically and directly when calling from the caller's phone number and immediately responding to the emergency order issued by individuals when calling the emergency number, which helps police stations, security patrols, road security, the public authority, civil defense, ambulances, fire trucks, etc. in making receiving calls and locating easy, fast and accurate process.

We're talking about the potential to save lives, when ambulances are brought to the scene quickly and safely in an emergency.

When minutes and seconds are valuable, the procedure centers such as (hospitals/emergency services/police stations . . . etc) take a long time to select, organize and send an appropriate emergency vehicle to the appropriate location, and the time taken to get the location data of the caller.

The second part of the invention in its security system, which is concerned with the presence of distributed surveillance cameras in addition to security systems and sensors such as the weapon detection system.

Among the previous similar technologies in the same field with regard to surveillance cameras, there are many advanced surveillance cameras that are used by individuals in houses, companies, stores and offices etc, for security purposes.

While in the current invention of this innovative idea, these innovative security cameras with comprehensive features are used and distributed in the areas, main streets and side roads by the relevant government offices, so their purpose will be to provide more security in the community.

We come to mention the feature of security systems and sensors in the current invention, in the following narrative is a statement of exactly how secret weapons detection systems work, as weapons it's been changed dramatically in recent years, with the emergence of 3D printing recently, many have concerns about 3D printed guns and others of weapons however, the detection of modern weapons uses different techniques.

Modern weapons detection systems have made leaps and bounds over their counterparts just a decade ago.

Legacy systems often rely on every individual intending to enter a building to pass through screening, and in some cases X-rayed their possessions, such as in airports.

These systems were heavy, often requiring technicians when problems arose, and were not as effective as we had hoped, given the amount of active shooting incidents that occurred during those years.

There were many flaws in these old systems which have been corrected by the newer ones.

These systems usually only allow one person to pass at a time, even with two of these systems, it often causes jams and unnecessary strain.

Many personnel were needed not only technicians but also many security personnel to direct the people.

The purpose of these systems is to make people feel more secure, but when it's a huge machine with armed security guards standing around it, most people will feel more uncomfortable than without it.

They will take up huge space that many of these older systems require major space that the scanning device will need to allow people of all shapes and sizes to fit in and take up space in doorways.

In recent years, clandestine weapon detection systems have abandoned the heavy metal detection aspect and instead used more modern techniques which are Artificial Intelligence (AI) and deep learning are two major basic systems in modern detection systems, both for weapons and for detecting other things.

In the current invention system, this integrated security system of security sensor systems is used to detect weapons and prohibited substances on a community scale not specific places such as airports, shopping centers and other places that contain a large group of people and require passing through the security device for detection.

The innovative idea enables all security centers to monitor all areas in the country and provide protection for the community, where any danger to the community is detected before it occurs.

### SUMMARY OF INVENTION

The purpose of this invention in light of the above is to provide a system and program to track and monitor the location of the caller, as soon as he calls the security center, the location appears directly on the screen at the center, police stations, security patrols, road security, the public authority, civil defense, ambulances and fire trucks to make receiving calls and locating easy, fast and accurate process.

We're talking about the potential to save lives, when ambulances are brought to the scene quickly and safely in an emergency case.

When minutes and seconds are valuable, the procedure centers such as (hospitals/emergency services/police stations . . . etc) take a long time to choose in organizing and dispatching an appropriate emergency vehicle to the appropriate location.

This security system also contains specialized surveillance cameras and security sensors established by specialized government security offices and platforms, because they are authorized to place these cameras with innovative security features in areas, neighborhoods and streets, in addition to the security sensors system.

According to the embodiment of the invention, this objective in the invention is achieved, that as soon as an individual calls the unified emergency numbers directly, his position at the center is shown in the screen and in the same way his location is shown to the nearest security unit.

If he calls the emergency number, and he asks for an ambulance, for example, his location appears on the screen at the center directly with all the details, and it also appears at the nearest ambulance to his area to be reached with ease and in record time.

This system works by electronically linking all communication networks and SIM cards with phone numbers at the state level to the security centers, including emergency, police, civil defense, ambulance and others, through a high-accuracy positioning system and electronically linking it to all numbers for all communication networks in the country, and that the emergency center contains All numbers with all data, as soon as any contact is received from individuals, the number appears with the location directly, even if the person is unable to explain his condition and give information about his location clearly due to what he is going through, as the security support will reach him in record time to his location directly and follow up on his condition.

The second security part in this system is through the presence of the cameras that are distributed in the regions, the main objective of them is to help the security offices to follow up on any suspicious cases that may occur in the region, so that the work and the screens of these cameras are searched and inspected by the employee in the central unit of the security and emergency office of each region by inspecting the cases of kidnapping, loss and suspicious cases to know the progress of movements in the area, the presence of these cameras directed and distributed on main streets and side roads, which prevents the concealment or disappearance of any abnormal situation that occurs in the area, so that it is possible to know where the person went to the last point, where he stopped, what he did and what he was exposed to.

This security system serves government agencies as well as the personal interests of individuals when they are harmed, or when the car is stolen, or something like that, which contributes significantly to reducing the rates of crimes that occur in society.

Also, this device and the security system contain another part, which is the presence of security sensors which will be mentioned in detail in the following description.

The presence of sensors that detect weapons, explosives and narcotics, excluding the licensed police devices, and the possibility of issuing an alert to the nearest security center in the area when there is a weapon, and the nearest police car heading to the target that appeared in the system at the security center, and all security vehicles also contain a system for an immediate alert that has been issued by the security center in the region when there is any suspicious case.

Sensors metal detectors are called long-range survey devices and are suitable for distance search in open and wide lands, these devices are characterized by a large scanning field.

The advantages of the invention are in the following points:
The system helps the security center to quickly communicate and respond to the emergency order issued by individuals inside the country when calling the emergency unit number, which helps the security centers in the country such as the police, security patrols, the public authority, civil defense, ambulances and fire trucks in making the receiving of calls and locating process easy, fast and accurate.
When the person calls the emergency department, whether the police or the ambulance, this system saves time for both the security center and the individual to take information from the caller during questioning and take details of his condition and the location information to reach him and follow up on his condition and rescue him.
The possibility of following up any action on any subject automatically by phone.
The security men in the areas were able to monitor any violations that might occur.
The results through this invention may have significant implications for the security sector, in terms of the ability to support healthcare and industry, with the presence of sensors that detect weapons, explosives and prohibited substances.
The cameras distributed in the regions, the main objective of it, lies in helping the security offices to follow up on any suspicious cases that may occur in the regions.
This security system serves government agencies as well as the personal interests of individuals.

### DETAILED DESCRIPTION OF INVENTION

According to the following invention, which consists of an integrated security system, the first part of the system is for tracking and monitoring the location of the caller, and the second part is a system and a device that contains security sensors and cameras distributed in areas that contain several comprehensive security features in one system.

First: The security system for tracking SIM cards.

The definition of the system that we are going to talk about now is a system to track and monitor the location of the caller, as soon as he calls the security center; the location appears directly on the screen at the center.

It is a service that helps the security center to quickly communicate and respond to the emergency order issued by individuals within the country when calling the emergency unit number, which helps Police Stations, Security Patrols, Road Security, Public Authority, Civil Defense, Ambulances and Fire Trucks make receiving calls and locating easy, fast and accurate process.

We're talking about the potential to save lives, when ambulances are brought to the scene quickly and safely in an emergency.

When minutes and seconds are valuable, the procedure centers such as (hospitals/emergency services/police stations . . . etc) take a long time to choose, organize and dispatch the appropriate emergency vehicle to the appropriate location.

When the individual faces some emergency incident, such as suddenly suffering from an emergency health condition that needs rapid medical intervention, he will call an ambulance and the emergency unit receives his call, the service representative will ask him about his condition and take details of his location.

His condition may worsen, as well as if the individual is subjected to any assault and wants to communicate with the police to report, and when the Central Security Unit receives his call, his information will be taken in the same way by asking about his condition and his location so that the nearest security patrol is sent to him and the passage of time in taking information from the individual may it puts him at risk, the caller will surely be reached but the time factor is very important in controlling the situation.

The innovation of this security system and how it works lies in the fact that as soon as the individual calls the unified emergency numbers directly, his location in the center will appear on the screen, and in the same way his location is shown to the nearest security unit patrol.

If he calls the emergency number, he will ask for an ambulance, for example, his location will appear on the screen at the center directly with all the details, and it also appears at the nearest ambulance to his area to be reached with ease and in record time.

This system works by electronically linking all communication networks and SIM cards with phone numbers at the state level to the emergency center, through a high-accuracy positioning system and linking it to all numbers for all communication networks in the country, and that the emergency center contains all numbers with all the data as soon as any contact is received from individuals the number will appear with the location directly, even if the individual is not able to clearly explain his condition and location, due to what he is going through.

A GPS tracker is a device used to monitor something or someone's location from a distance.

The device sends the data to GPS satellites, which then routes the information to the security center or phone number connected to the device owner.

The GPS tracking device (Global Positioning System) is a small device that is electronically integrated with communication chips and is used for tracking and determining the location by calling the emergency center using satellites.

The electronic tracking built into the chips sends these signals to the website of the tracking system on the Internet and the system of the security center, which displays the coordinates of the whereabouts of the individual who made the call on the map.

The tracking feature is via a radar embedded in the SIM cards electronically via phone numbers and that the alert reaches the central emergency unit and the nearest patrol in the incoming call area, it is a programmed system established by the government security system and is not hack able.

So that if a call is issued to the security offices, the contact details and location appear to them, and the location details are sent to the police or the ambulance for example, so that the nearest patrol in the neighborhood reaches the location from which the call was issued.

It was mentioned that all central units of the security and emergency offices contain all numbers data, as well as the patrols of each region or neighborhood containing this data. When any call is issued to the emergency center, this center sends the location details directly to the nearest patrol of the region from which the call was issued.

The incoming call at the security center, the security patrol in the same area from which the call was issued, whether the police car or ambulance etc, can hear the incoming call and what happened and started heading directly towards the site, the call and the location details appeared in their car, because it is also connected to the central unit of the security offices and emergency, to reach the owner of the case before things escalate and become dangerous, which saves time in taking the location information from the caller.

Second: The security system and apparatus that contains the cameras distributed in the regions, in addition to the security sensors.

This security system contains specialized surveillance cameras and security sensors installed by the relevant government security offices, because they are authorized to place these cameras with innovative security features in areas, neighborhoods and streets.

1—The cameras distributed in the regions, the main objective of which lies in helping the security offices to follow up on any suspicious cases that may occur in the region. Inspect cases of kidnapping, loss and suspicious cases to know the progress of movements in the vicinity, the presence of these cameras directed and distributed on main roads and side streets, which prevents the concealment or disappearance of any abnormal situation that occurs in the area, so that it is possible to know where the person went to the last point, where he stopped, what he did and what he was exposed to, this security system serves the government agencies as well as the personal interests of individuals when they are harmed, the car is been stolen, or something like that.

This security system is able to help the security authorities, which contributes significantly to reduce the percentage of crimes that occur in society.

This system and the security device carries several lenses for the camera, and these lenses are a front lens, a rear lens, a right lens, a left lens, and a bottom lens that moves at different angles at a rate of 360 degrees.

### The Camera Specifications:

Colored night photography feature, which is a new and distinctive feature in modern surveillance cameras that helps provide colorful night photography with the lowest light percentage in night photography in poorly lit or dark places as it contains a larger sensor and its sensitivity to lighting is higher and more accurate than cameras with traditional night photography, in order to introduce a greater amount of light, thus capturing high-resolution color night photos, and the quality is close to the accuracy of daytime photography.

This feature is called super starlight

Ultra-clear and high-resolution image in the darkest shades, given that most suspicious cases and organized crimes occur at night, it was necessary to have the feature of night photography, which would help the security authorities, through the use of infrared rays; In order to see what cannot be seen with the naked eye.

This feature has a high ability to take very clear pictures in the dark; due to the sensitive imaging chipset.

Most types of night surveillance cameras have an LED flashlight, which works at night to clarify the details and features of the image with high accuracy and quality.

Also, you cannot worry and be disturbed about difficult lighting conditions, as the camera is able to produce visual images with high accuracy; this is because it uses wide dynamic range technologies and infrared.
The cameras are connected to the central unit of the Security and Emergency Office and support recording and saving via the cloud storage service.
It has an internal microphone.
Resistant to environmental factors by using the DX-3100 Aquapix system for water and dust resistance, high temperature and extreme cold resistance, it is freeze resistant to 14° F. (−10° C.) or more, in addition to being installed under a hard cover for further protection.

JIS Standards The most commonly quoted standards for environmental protection are those developed by the Japan Standards Association (JIS), which cover dust and water protection. From particle exclusion greater than 1 mm in diameter to complete dust exclusion, when it comes to waterproofing, JIS provides protection from the rain.
The camera has a strong focal length lens for large distances, it contains optical zoom by zooming in on the subject and the ability to make photos farther and closer.
The Charging method: The cameras work through their connection to the security center and supply the cameras with electricity for operation because they will be distributed outside in the main and sub-streets, and electricity will be delivered to them from electricity poles, in addition to containing permanent internal rechargeable batteries that work by absorbing light from sunlight to supply. The batteries are powered by cells and the solar panel.

These batteries are useful for backup in case of a sudden power outage; the batteries are supplied with energy to keep the cameras working continuously.

The use of an integrated solar power system is a professional and guaranteed solution that will provide the monitoring system with stability and the necessary energy in distance areas where there is no electricity; a complete solar power system can provide energy without problems.

2—The security sensors belonging to the aforementioned security system that was mentioned with the cameras.

These security sensors are located in an integrated security apparatus distributed in all regions besides the presence of cameras.

It was previously mentioned that this security apparatus contains cameras distributed according to the previous detailed description of the camera specifications.

Also, this security device and the security system contain another part, which is the presence of security sensors, which will be mentioned in details in the following detailed description.

The presence of the sensors that detect weapons, explosives and drugs, excluding the licensed police, and the possibility of issuing and sending alerts to the nearest security center in the area when there is a weapon, and the nearest police car heading to the target directly that appeared in the system at the security center, and all security cars contain an immediate alert system issued by the security center of the region when there is any suspicious case.

* This system and the security program in the current invention to detect weapons contain multiple modern systems that can be used and will be mentioned in the following description *

Sensors metal detectors are called long-range survey devices and are suitable for distance search in open and wide lands, these devices are characterized by a large scanning field.

It has search antennas to receive signals coming from metal objects, and the antennas head towards the target place and by repeating the search from four sides, the target site can be reached with greater accuracy until it is confined within a small area.

In distance communication systems, the alarm sensor has many of the following concepts: In telecommunication systems, it is a device used to sense abnormal conditions in the system and to give a signal that determines the presence and nature of system anomalies to the alarm indicator, whether it is local or distance.

It can identify incidents ranging from the opening and closing of a simple switch to the automatic time-phase closing and re-start of the cycle.

In a physical protection system, it is a device used to indicate a change in the physical environment.

In electronic protection systems, it is a physical device that notices the change (presence) of any signal (component) and that prompts a switch in an electronic circuit to perform a special operation for an application.

In electronic alarm systems, the use of this key is done by a group of devices to sound the alarm or to carry out a specific protection task through the telephone lines.

Note: The alarm sensor can be redundant or in chains, just as an alarm sensor is used to protect the home, cable or power and is protected by another alarm sensor.

The distance sensing system has the advantage of automatically switching to search systems once the parts for each system are installed.
1—Three-dimensional imaging search system.
2—The long-range sensor search system.

The front range of the device may reach 3000 square meters or more, with a depth of 2 kilometers in the ground or more.

Super speed in capturing targets and locating them.
3—A two-dimensional imaging system to determine the depth and analyze the results of the research.

### Long Range Radar System:

It works with a single radar sensor system with a radar structure Characterized by the analysis of radar waves specialized in measuring the characteristics of targets.

It is a high-resolution dual frequency radar transmitter and receiver of the signal emitted by the targets a radar system that relies on special algorithms to detect the location of the target, with a coherent ability to detect and measure targets.

### 3D Imaging System:

This system is designed to avoid errors caused by the use of the sensor system and to confirm the presence of the target.

After identifying the target with the radar system, you can photograph the detected target using the 3D imaging system.

High accuracy in identifying metal objects such as weapons and ammunition by metal detector sensors, security devices that detect weapons and are detected by sending an alert to the office console to alert officials, and the degree of metal sensitivity is very high, it may reach almost 100 degrees, where there are three degrees of sensitivity low, medium and high to detect weapons, explosives and drugs.

X-ray technology system is to monitor and detect any explosive material, even if it is in very small proportions, or weapons or any other things, as this system depends on examining everything that passes next to it, whether fixed or moving.

The examination device placed on the side of the security apparatus sends waves to the security office and to pass through all solid objects, whether fixed or moving, and penetrates everything such as a metal detector.

The system operator receives and displays all the captured images in front of the computer, determines whether there are any violating materials such as firearms and notifies the security authorities.

* In the following description, the use of a modern technology in detecting weapons and prohibited substances for the current invention of the security system and program *

Artificial intelligence is a technology-based system that includes many advanced tools and networks that can simulate human intelligence, while not threatening to replace physical human existence.

Artificial intelligence uses systems and software that can interpret and learn from input data to make independent decisions to achieve specific purpose.

Artificial Intelligence: Networks and Tools Artificial Intelligence includes several areas of the method, such as reasoning, knowledge representation, and search for solutions, among which is a basic machine learning (ML) model.

ML uses algorithms that can recognize patterns within a set of further classified data.

A subfield of ML is deep learning (DL), which involves artificial neural networks (ANNs). These comprise a set of complex and interconnected computing elements that include “perception” analogous to human biological neurons, simulating the transmission of electrical impulses in the human brain.

Artificial neural networks form a group of nodes, each of which receives separate inputs and eventually transforms them into outputs either single or multi-link using problem-solving algorithms.

Artificial neural networks include different types, including Multilayer Perceptual Networks (MLP), Recurrent Neural Networks (RNN), and Convolution Neural Networks (CNNs), which use either supervised or unsupervised training procedures.

An MLP network contains applications including pattern recognition, optimization aids, process identification, and controls, and is usually trained by one-way supervised training procedures, and can be used as global pattern classifiers.

RNNs are closed-loop networks that have the ability to store information, such as Boltzmann constants and Hopfield networks.

They are a series of dynamic systems with local connections, characterized by their topology, and they are used in image and video processing, biological system modeling, and complex brain function processing.

Patterns and advanced signal processing, more complex forms include Kohonen networks, RBF networks, LVQ networks, counter-propagation networks, and ADALINE networks 9.

The use of artificial intelligence technology is one of the modern methods of detecting weapons.

Many are familiar with artificial intelligence, but deep learning may seem a more alien concept; simply put it is a computer system that simulates our neural network to allow new information to be collected and stored. Basically deep learning systems allow computers to learn over times through input such as video feeds from security cameras.

What this means for weapons detection systems is a high degree of accuracy in weapon recognition, as well as the ability to detect potential threats before they even begin.

These systems are also capable of facial recognition, breaking things down into binary information.

The use of the Internet of Things (IOT)

The Internet of Things is another aspect of modern technology.

It is simply refers to the interconnected nature of many modern technologies, and how we can take advantage of them all, as the case with the Internet.

There are many different technologies that can be used in conjunction with modern weapon detection systems, including:

Motion Detection Sensors this security system that contains cameras and security sensors is equipped with deep learning technology.

The most effective covert weapons detection systems will use all of the above technologies together to ensure maximum effectiveness.

Empower this security apparatus on how to detect weapons, by teaching artificial intelligence how to distinguish and identify weapons in security cameras.

This proprietary video analytics technology enables this capability, resulting in an extra layer of security without increasing anxiety levels.

Development of special video analytics technology all weapon detection is a component of a multi-level security approach.

The software integrates with the camera systems and the video analytics to detect weapons in actual time.

Existing video feed using existing security cameras, video analytics technology improves the ability to detect weapons through early detection; the security center has the correct details in actual time so they can immediately respond to real gun threats with greater accuracy than other security options.

Human verification is critical to ensuring accuracy with (AI) across platforms, and the military expertise of monitoring personnel, monitoring every discovery 24/7, and once a threat is verified they will notify the appropriate security personnel and first responders immediately, reducing response time and saving lives.

Combined with (AI), weapon detection capabilities using emergency response technology provide first responders with the real-time information they need to make accurate and more informed decisions.

In an emergency, integration allows the security center in each district to send critical data directly to local emergency agencies through the security center's own platform, taking a multi-step process of up to seconds.

When the weapon is detected in the operator's screen at the security center, an image appears on the screen with a specific code to identify the presence of the weapon, and then the system will know that it is a pistol.

The trigger will optimize the image to check if it is a weapon or not in less than 1 second.

After verification, the operator at the security center presses the “Send” button or determines that the alert was a false positive.

If the operator presses the “Submit” button, a series of alarm steps will be immediately performed.

The alert is distributed to the security center of each district at the same time the local security patrols at the scene will receive this alert in a very short time on their mobile phones and desktops.

The operations center has redundant systems to ensure it is always up and running 24/7, including multiple locations across the country, multiple internet lines, and backup power sources.

Everywhere there is a camera with coverage over time, weapons detection with actionable visual information through location and description.

Confirm each alert through the security center and alert the security to be the first responders in a very record time.

Combining artificial intelligence and weapons detection with RapidSOS emergency response technology providing first responders with the real-time information they need to make accurate, more informed decisions.

Through artificial intelligence, a weapon detection solution that is integrated into security cameras to detect the presence of a weapon carried by a person, where the weapon detection technology scans everywhere through special cameras distributed with coverage over time from the operations center of the security center of the region.

Once an alert is sent, security teams and first responders will be able to pinpoint the exact location of the threat with a full description of the perpetrators and the type of weapon marked.

The system detects weapons as soon as they appear on the camera, and reports threats before shots are fired, this provides quick response to the situation and law enforcement in record time.

Deep learning algorithms (AI) technology uses a convolution neural network to replicate how the human brain processes information.

Cutting-edge data science the system is trained to recognize weapons from hundreds of thousands of images in a proprietary data set.

With unmatched accuracy the system automatically identifies weapons in camera shots instantly, with over 99% detection accuracy in just seconds.

Eliminating false alarms advanced (AI) technology eliminates false alarms by working seamlessly in different environments and lighting.

The system integrates with existing cameras and video management systems, turning passive infrastructure into a proactive layer of security.

The (AI) system is completely cloud-based for ease of integration and thus does not require any new hardware which speeds up implementation and reduces IT burden, with minimal bandwidth usage.

Designed to manage privacy and bias, the system is the most privacy-focused and compliance-focused (AI) security solution, providing stakeholders with peace of mind about physical security without raising cyber security or privacy concerns.

Cloud deployments centralize network traffic, reducing congestion on local networks and simplifying network management, with only modest increases in Internet bandwidth usage.

Internet-based integrations use simple, open APIs hosted on servers with world-class security and maintenance, reducing IT maintenance.

The system does not analyze individuals there is no facial recognition or search function that could lead to bias or breach of privacy.

The system focuses on analytics, activation and only sends alerts when a threat such as a weapon is detected.

This security device can also give quick test results to detect drugs and prohibited substances such as morphine, methamphetamine, ketamine, etc. It can also determine the amount of these drugs.

Advanced (AI) and X-ray can detect 100% of drugs and explosives illegal and dangerous items, such as explosives, can be detected with 100% efficiency, using artificial intelligence (AI) and a new X-ray approach.

Some explosives can be difficult to detect using traditional X-rays alone, and the new method could revolutionize how illegal products such as illegal drugs and explosives are detected.

This is a radically different way of examining materials and objects through texture analysis, and offers a new way to detect illegal substances.

Small bends in X-rays have always been there, but they are invisible to conventional X-ray systems, so this gives us access to a huge amount of previously untapped information.

The new x-ray detection system will detect illegal and dangerous items, such as explosives and drugs.

This is by integrating the new X-ray measurement technology with machine learning for artificial intelligence, and testing it in a specially developed X-ray scanner using objects containing hidden explosives as well as safe objects.

Microscopic changes or irregularities in objects cause X-ray beams to bend as they pass through them.

The new method is based on measuring these tiny curvatures as the beam moves through objects of different textures.

Bending occurs at angles as small as micro radians, which are about 20,000 times smaller than a degree.

Integrating the measurement of these angles known as micro radian scattering with artificial intelligence to accurately identify objects and materials through their texture.

1. The integrated security system to assist the security services in protecting and assisting communities in the first part of the system for tracking contacts.
It is a system for tracking and monitoring the location of the caller as soon as he calls the security center. The location appears directly on the screen at the center, it is a service that helps the security center to quickly communicate and respond to the emergency order issued by individuals within the country when calling the emergency unit number, which helps police stations, security patrols, road security, and the public authority, civil defense, ambulances and fire trucks
Make receiving calls and locating easy, fast and accurate process.
We're talking about the potential to save lives, when ambulances are brought to the scene quickly and safely in an emergency.
When minutes and seconds are valuable, the procedure centers such as (hospitals/emergency services/police stations . . . etc) take a long time to choose organize and dispatch the appropriate emergency vehicle to the appropriate location.
When the individual faces some emergency incident, such as suddenly suffering from an emergency health condition that needs rapid medical intervention, he will call an ambulance, and the emergency unit receives his call, the service representative will ask him about his condition and take details of his location.
His condition may worsen, as well as if the person is subjected to any assault and wants to communicate with the police to report, and when the central security unit receives his call, his information will be taken in the same way by asking about his condition and his location so that the nearest security patrol is sent to him and the passage of time in taking information from the individual may it puts him at risk, the caller will surely be reached but the time factor is very important in controlling the situation.
The innovation of this security system and how it works lies in the fact that as soon as the person calls the unified emergency numbers directly, his location in the center will appear on the screen, in the same way his location is shown to the nearest security unit.
If he calls the emergency number, he will ask for an ambulance, for example, his location appears on the screen at the center directly with all the details, and it also appears at the nearest ambulance to his area to be reached with ease and in record time.
This system works by electronically linking all communication networks and SIM cards with phone numbers at the state level to the emergency center, through a high-accuracy positioning system and linking it to all numbers for all communication networks in the country, and that the emergency center contains all numbers with all data as soon as any contact is received from individuals the number will appear with the location directly, even if the individual is not able to clearly explain his condition and location, due to what he is going through.

2. The integrated security system to help the security services protect and assist communities in the second part. This security system contains specialized surveillance cameras and security sensors established by the relevant government security offices, because they are authorized to place these cameras with innovative security features in areas, neighborhoods and streets.
The cameras are distributed in the regions, and the main objective of them is to help the security offices to follow up on any suspicious cases that may occur in the region, so that these cameras are searched and inspected by the employee in the central unit of the security and emergency offices of each region, by inspecting the cases of kidnapping, loss and suspicious cases to know the progress of movements in the areas, the presence of these cameras directed and distributed on main roads and side streets, which prevents the concealment or disappearance of any abnormal situation that occurs in the area, so that it is possible to know where the person went to the last point, where he stopped, what he did and what he was exposed to.
This security system serves the government agencies as well as the personal interests of individuals.

3. According to claim 2, this system and the integrated security program to assist the security services contain security sensors established by the relevant government security offices.
The security sensors of the aforementioned security system that were mentioned with the cameras.
These security sensors are located in an integrated security apparatus distributed in all regions besides the presence of cameras.
It was previously mentioned that this security apparatus contains cameras distributed according to the previous detailed description of the camera specifications; also this security device contains another part which is the presence of security sensors in the security system present.
The presence of sensors that detect weapons, explosives and prohibited substances, excluding the licensed police, and the possibility of issuing and sending alerts to the nearest security center in the area when there is a weapon, and the nearest police car heading to the target directly that appeared in the system at the security center, and all security cars contain an immediate alert system issued by the security center of the region when there is any suspicious case.
